(19) United States
(12) Patent Application Publication
(10) Pub. No.: US 2010/0282897 A1
(43) Pub. Date: Nov. 11, 2010

(54) Unmanned Aerial Surveillance Device

(75) Inventor: Samuel de la Torre, Riverside, CA (US)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignee: Chang Industry, Inc.

(21) Appl. No.: 11/464,973

(22) Filed: Aug. 16, 2006

Related U.S. Application Data
(60) Provisional application No. 60/708,889, filed on Aug. 17, 2005.
(60) Provisional application No. 60/752,478, filed on Dec. 21, 2005.

(51) Int. Cl. B64C 3/56; B64C 3/00; G01C 21/00; F42B 25/00; H04N 7/18

(52) U.S. Cl. 244/49; 244/35 R; 701/206; 102/382; 348/144; 348/E07.085

(57) ABSTRACT

An aerial surveillance device is provided, comprising an image capturing device capable of being supported by an airframe structure above the ground. The airframe structure includes a body portion defining a longitudinal axis and configured to support the image-capturing device. A tail portion having control surfaces is operably engaged with the body portion along the axis. Transversely-extending wing portions are directly engaged with the body portion. Each wing portion is defined by longitudinally-opposed spars extending from a spaced-apart disposition at the body portion to a common connection distally from the body portion. The spars have a fabric extending therebetween to provide a wing surface. A support member extends along an aerodynamic center, transversely to the body portion, of each wing portion, to tension and rigidify the wing portions so as to provide a positive camber for the wing portions and to form an airfoil.

### CROSS-REFERENCE TO RELATED APPLICATIONS

This application claims the benefit of U.S. Provisional Application No. 60/708,889, filed Aug. 17, 2005, and U.S. Provisional Application No. 60/752,478, filed Dec. 21, 2005, which are incorporated by reference herein in their entirety.

### BACKGROUND OF THE INVENTION

1. Field of the Invention

The present invention relates to a surveillance device and, more particularly, to a stowable unmanned aerial surveillance device.

2. Description of Related Art

In certain situations, it may be desirable or even necessary to view or survey a scene from above. However, such surveillance may often be difficult to conduct in person due to the limitations of being able to physically obtain the necessary views. As such, various unmanned aerial surveillance devices have been proposed. One such example of a surveillance device is the “Cyber Bug” device produced by Cyber Defense Systems of St. Petersburg, Fla. The Cyber Bug appears to comprise a conventional uni-body or monolithic fuselage, wherein such a “box” design includes access doors or panels placed at strategic locations for receiving various components. The fuselage includes a tail section having a horizontal stabilizer, a vertical stabilizer, a rudder, and an elevator, wherein the vertical stabilizer and the rudder are mirrored below the centerline of the craft. An electric, tractor-configured propulsion system with a folding propeller is located at the nose portion of the fuselage. The fuselage is suspended via a connecting member beneath a delta-shaped hang-glider type canopy or main wing. The main wing includes a delta-shaped frame having a fabric attached to the frame members for forming the wing envelope. Similar to a hang glider, the fabric loosely extends between the frame members and is unsupported at the trailing edge. Autonomous flight and surveillance capabilities appear to be provided.

However, surveillance devices such as the Cyber Bug implement a uni-body or “box” design fuselage that is bulky and that may suffer from poor space management for the payload capacity. The weight of such a fuselage may also be detrimental to the flight efficiency of the craft. Such a configuration may also result in an undesirable bulkiness for storing the craft when not in use. Further, the use of the low aspect ratio control surfaces (rudder and elevator) may not provide sufficient response or authority, even when coupled with the corresponding stabilizers. In addition, the use of an additional vertical stabilizer and rudder may also undesirably increase the weight of the craft. Also, the fabric loosely attached to the delta-shaped frame is dependent on a fixed flight angle to maintain the canopy in the “inflated” shape to provide the necessary lift to keep the craft aloft. However, if the craft is disrupted from the optimum flight angle, and the fabric loses the “inflated” shape, the craft may tend to enter an unrecoverable dive at the risk of catastrophic damage thereto.

Thus, there exists a need for an unmanned aerial surveillance device that is lighter, less bulky, durable, responsive, and stable, wherein such a device should preferably be able to accommodate various components and sub-assemblies, as well as any payload, in an efficient and readily adaptable manner.

### BRIEF SUMMARY OF THE INVENTION

The above and other needs are met by the present invention which, in one embodiment, provides an unmanned aerial surveillance device, comprising an image capturing device operably engaged with an airframe structure configured to be capable of supporting the image-capturing device at an above-ground altitude. Such an airframe structure includes an elongate body portion defining a longitudinal axis and configured to support the image-capturing device. A tail portion is operably engaged with the body portion along the axis and comprises a rudder control surface and an elevator control surface. A pair of transversely-opposed wing portions is directly and operably engaged with the body portion and each extend substantially transversely thereto. Each wing portion is defined by longitudinally-opposed spars extending from a spaced-apart disposition at the body portion to a common connection disposed distally with respect to the body portion. The spars have a fabric extending therebetween so as to provide a wing surface. A support member extends along an aerodynamic center, transversely to the body portion, of each wing portion, wherein the support members are configured to tension and rigidify the respective wing portion so as to provide a positive camber for each wing portion and to form an airfoil.

Embodiments of the present invention thus provide significant advantages as further detailed herein.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a stowable unmanned aerial surveillance device according to one embodiment of the present invention;

FIGS. 2A-2D are bottom, side, top, and front views, respectively of a stowable unmanned aerial surveillance device according to the embodiment of the present invention shown in FIG. 1;

FIG. 3 illustrates an image-capturing device supported by an unmanned aerial surveillance device according to one embodiment of the present invention;

FIG. 4 illustrates a power source for an unmanned aerial surveillance device according to one embodiment of the present invention;

FIGS. 5A and 5B illustrate rudder and elevator control surfaces implemented by an unmanned aerial surveillance device according to one embodiment of the present invention;

FIG. 5C illustrates an over-the-center hinge mechanism implemented in a folding control surface of an unmanned aerial surveillance device according to the embodiment of the present invention shown in FIGS. 5A and 5B;

FIGS. 6A and 6B illustrate an unmanned aerial surveillance device according to one embodiment of the present invention disassembled and/or folded for stowing in a container;

FIG. 7 illustrates a wingtip bracket implemented in an unmanned aerial surveillance device according to one embodiment of the present invention;

FIGS. 8A and 8B illustrate an over-center locking mechanism implemented in conjunction with a wing assembly of an unmanned aerial surveillance device according to one embodiment of the present invention;

FIG. 9 illustrates an unmanned aerial surveillance device according to one embodiment of the present invention with a deployed controlled descent and recovery system; and

FIGS. 10A and 10B illustrate wing configuration for an unmanned aerial surveillance device, implementing ailerons, according to an alternate embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

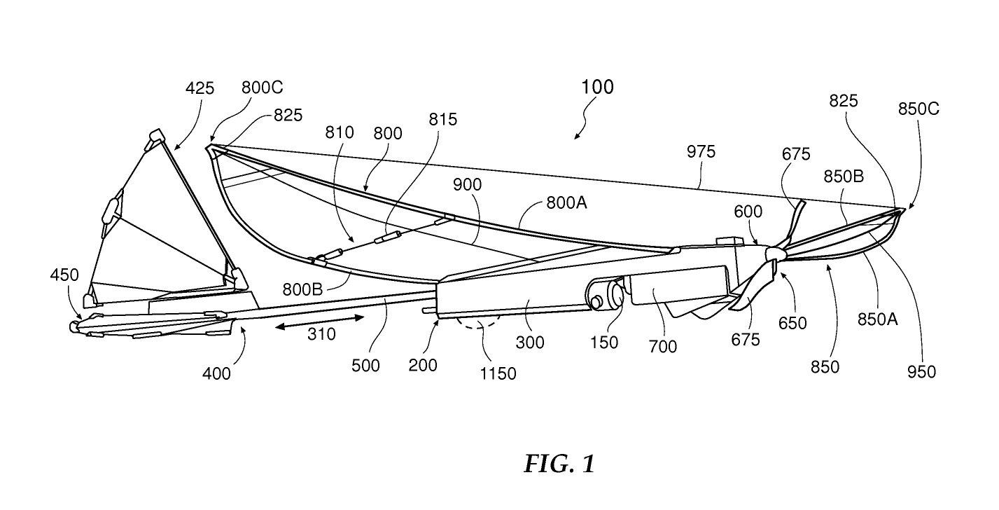

FIG. 1 illustrates an unmanned aerial surveillance device according to one embodiment of the present invention, the device being generally indicated by the numeral 100. The device 100 comprises an airframe structure 200 configured to receive an image-capturing device 150, wherein the airframe structure 200 is capable of autonomous flight, while supporting the image-capturing device 150, at different above-ground altitudes. In one particular embodiment, the device 100 is configured for relatively low level flight, as will be appreciated by one skilled in the art and discussed below in further detail, though such an exemplary embodiment is not intended to limit the capabilities of a device 100 as disclosed herein.

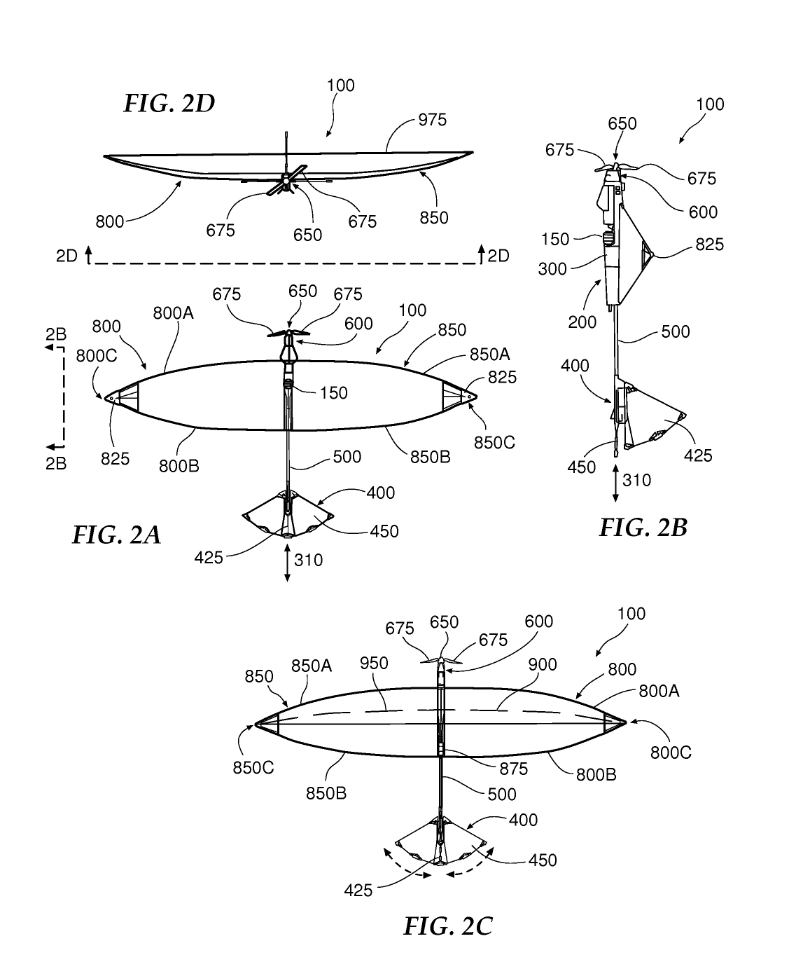

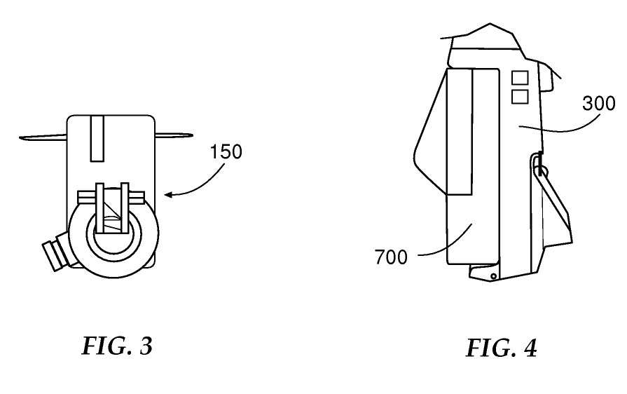

In one embodiment, as shown in FIGS. 2A-2D, the airframe structure 200 is based on, for example, a “pod and boom” design, incorporating an elongate body portion 300 (“pod”) defining an axis 310 and having a tail portion 400 connected thereto along the axis 310. In some instances, the tail portion 400 is connected to the body portion 300 via an extension member 500 (“boom”) such that the body portion 300, the extension member 500, and the tail portion 400 all extend along the axis 310 in an aerodynamic manner. The body portion 300, the extension member 500, and the tail portion 400 are preferably comprised of rigid, strong, and durable, but light, material such as, for example, a polymer or a carbon fiber or carbon-fiber composite that may include, in some instances, Kevlar™ or Aramid™ fibers. The body portion 300 is further configured to support the image-capturing device 150, wherein the body portion 300 may completely surround or, in other instances, comprise a series of panels disposed about the image-capturing device 150. For example, the body portion 300 may, in some instances, comprise a pair of composite side shells having components and/or subassemblies installed therebetween, which allows for more flexible placement of such components and/or subassemblies, as well as a more compact design of the airframe structure 200. In other instances, the image-capturing device 150 may be at least partially mounted outside the body portion 300, so as to be capable of being maneuvered or maneuvering without being constrained by the body panels. The image-capturing device 150 may include, for example, pan, tilt, and zoom capabilities, as well as visible light or night vision (infrared) capabilities. For instance, the image-capturing device 150 may be configured to pan through an angular range of about 160 degrees and to tilt through an angular range of about 60 degrees, with a pan-tilt mechanism (not shown) based upon a 2 inch diameter ball (see, e.g., FIG. 3). In some instances, the image-capturing device 150 may be stabilized with respect to the airframe structure. In some cases, the image-capturing device 150 may be, for example, gyroscopically stabilized, as will be appreciated by one skilled in the art. Such a configuration allows the device 100 to capture aerial surveillance images, whether still images or moving frames, while the airframe structure 200 is at an above-ground altitude.

In some embodiments, the airframe structure 200 may also have a propulsion device 600 operably engaged therewith (see, e.g., FIGS. 1 and 2A-2D). For example, the propulsion device 600 may also be housed by or otherwise engaged with the body portion 300, with the propulsion device 600 being configured to provide forward propulsion for the airframe structure 200. In one embodiment, the propulsion device 600 comprises an electrically-driven motor (not shown) configured to rotate a propeller member 650 having a plurality of blades 675. The propulsion device 600 may be configured in a tractor configuration or in a pusher configuration. As discussed further herein, one embodiment of the present invention includes a propeller member 650 having foldable blades 675 that can be folded along the body portion 300, generally parallel to the axis 310, so as to facilitate stowage of the device 100. Further, the airframe structure 200 includes a power source 700 (FIGS. 1, 4, 6A, and 6B) operably engaged therewith, as well as with the propulsion device 600 and the image-capturing device 150 for providing power thereto. The power source 700 may comprise, for example, a battery such as, for instance, one or more rechargeable lithium polymer cells housed in a singular power pod that is configured to be removably engaged (such as by a “quick-release” mechanism) with the body portion 300. When removably engaged with the body portion 300, the power source 700 is also electrically connected to the components of the device 100 for powering those components, as will be appreciated by one skilled in the art.

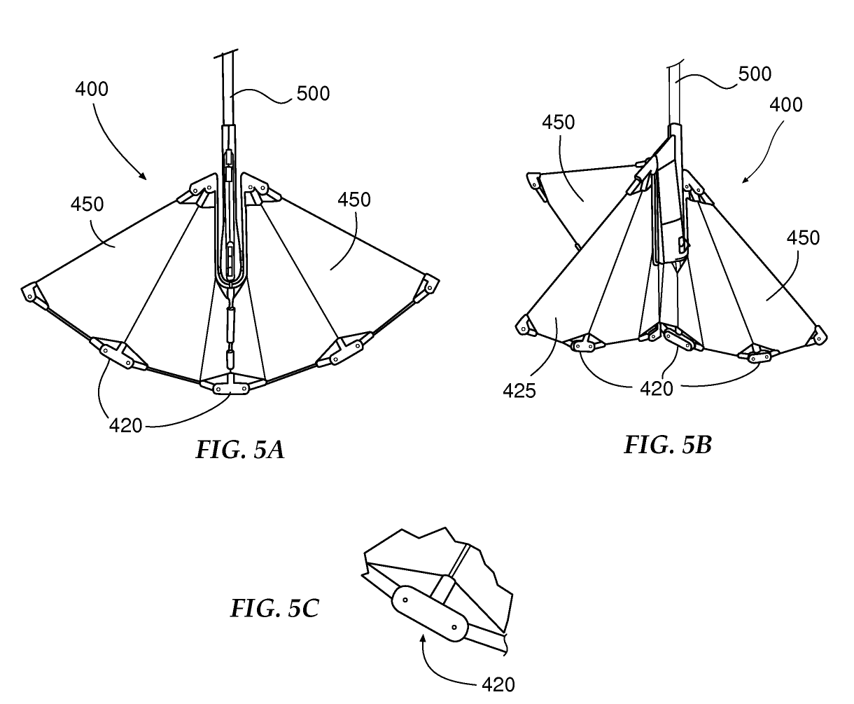

In order to provide flight controls for the airframe structure 200, the tail portion 400 comprises a rudder control surface 425 and an elevator control surface 450 (FIGS. 1, 5A, and 5B), each extending generally perpendicularly from the axis 310. In one embodiment, the elevator control surface 450 is substantially horizontal with respect to the level flight attitude of the airframe structure 200, while the rudder control surface 425 extends substantially vertically with respect to the level flight attitude. In particular embodiments, the rudder control surface 425 and the elevator control surface 450 are configured as “flying control surface” or “stabilizer-less” elements, wherein the entire control surface 425, 450 pivots on the aerodynamic center thereof. That is, there is no stationary portion of the respective rudder control surface 425 or elevator control surface 450 that acts as a stabilizer for the airframe structure 200.

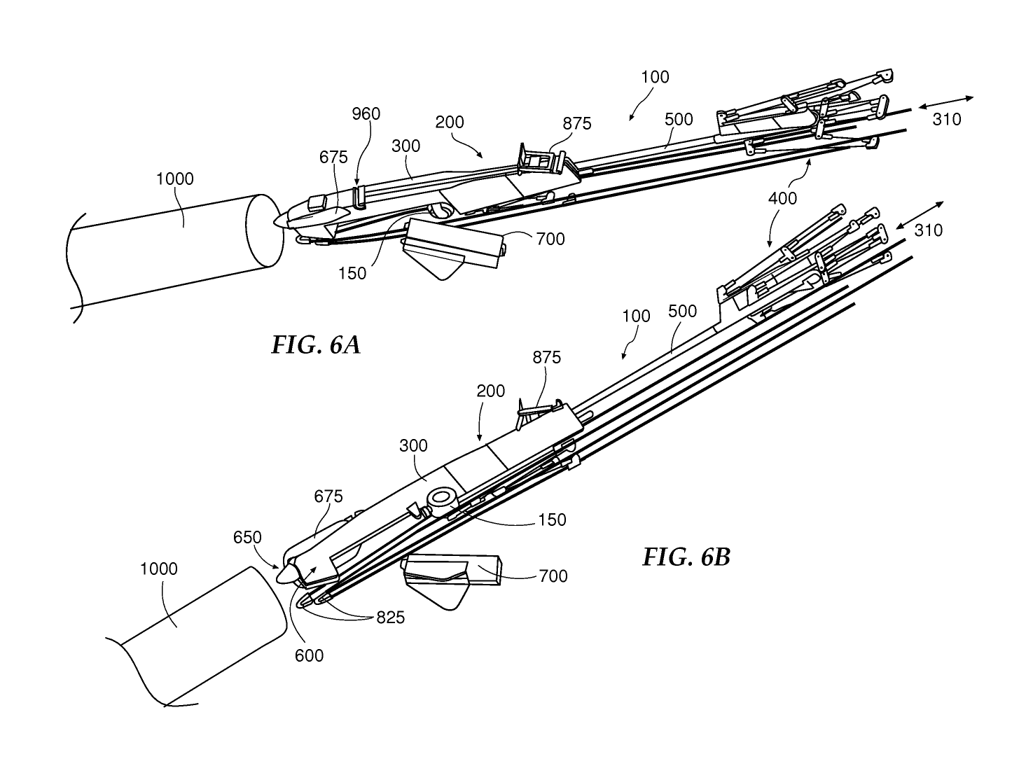

In one embodiment, each of the rudder control surface 425 and the elevator control surface 450 is comprised of a frame having a plurality of frame members pivotably attached at a leading edge thereof, wherein the trailing edges of the frame members are configured to be pivotable about the leading edge between a stowed position generally parallel to the axis 310 and a deployed position pivoted outwardly from the axis 310 (FIGS. 5A, 5B, 6A, and 6B). The frame members may also include one or more transverse members extending between the frame members so as to releasably lock the frame members in the deployed position. For example, in instances where the frame of one of the control surfaces 425, 450 includes two frame members, a transverse member can be attached to each frame member and the transverse members joined together therebetween by an “over-the-center” hinge mechanism 420 (FIGS. 5A-5C), as will be appreciated by one skilled in the art. In this manner, when the frame is extended to the deployed position, the transverse members and the hinge mechanism 420 cooperate to lock between the trailing edges of the frame members so as to lock and rigidify the frame (for instance, similar to the configuration and operation of an umbrella frame). The frame members and/or the transverse members may be comprised of, for example, rods or tubes made of rigid, strong, and durable, but light, material such as, for example, a polymer or a carbon fiber or carbon-fiber composite that may include, in some instances, Kevlar™ or Aramid™ fibers

Further, the frame of each control surface 425, 450 may also have a fabric extended thereover (either or both of the opposing surfaces of the frame, as shown in FIGS. 5A and 5B) and attached thereto such that, when the frame is locked in the deployed position, the fabric tautly extends across the frame to form the respective flight control (rudder or elevator) surface 425, 450. The fabric may comprise any fabric material having, for example, the strength, durability, tear resistance (i.e., a “rip stop” fabric), light weight, and/or other properties suitable for the application as disclosed, and as will be appreciated by one skilled in the art. In this manner and once assembled, each of the rudder control surface 425 and the elevator control surface 450 can be deployed (unfolded) as a handheld fan to form the flight control surfaces and, in the stowed (folded) position, extend substantially parallel to the axis 310 so as to facilitate stowing or storage of the device 100. Also, as previously discussed, the extension member 500 or “boom,” comprising, for example, a polymeric or composite tube, may be operably engaged between the body portion 300 and the tail portion 400 so as to form the fuselage of the airframe structure 200.

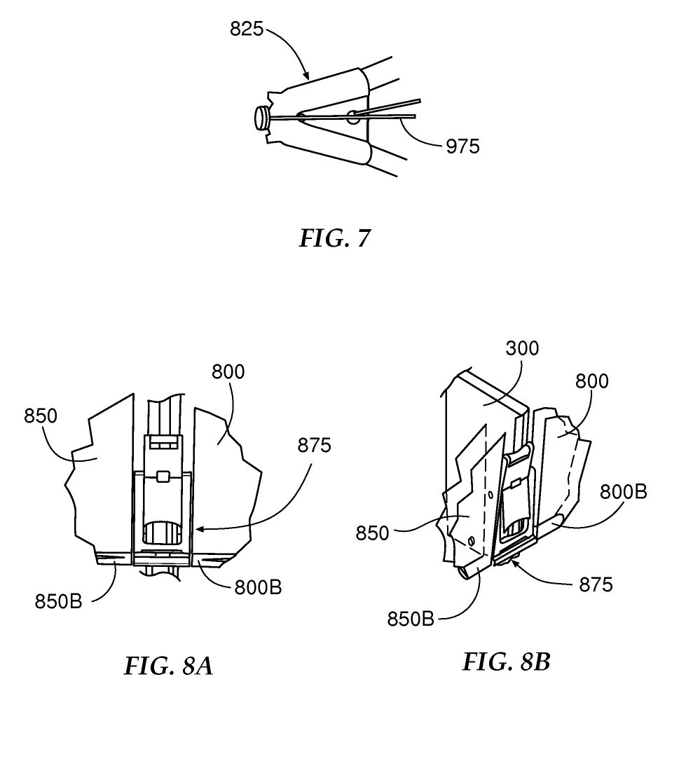

The airframe structure 200 further comprises a pair of transversely-opposed wing portions 800, 850 (FIGS. 1 and 2A-2D) operably engaged directly with the body portion 300 and extending substantially transversely thereto. Each wing portion 800, 850 comprises leading and trailing, or longitudinally-opposed, spars 800A, 800B, 850A, 850B, wherein the respective leading and trailing spars are operably engaged with and disposed in a spaced-apart relation along the axis 310 with respect to the body portion 300. The respective spars 800A, 800B, 850A, 850B extend substantially transversely outwardly of the body portion 300 and are attached at a common connection 800C, 850C (“wingtip”) via a wingtip bracket 825 (FIGS. 1 and 7). In one embodiment, the leading spars 800A, 850A are pivotably attached to the body portion 300 and/or extension member 500, while the trailing spars 800B, 850B can be removably secured to the body portion 300 and/or the extension member 500 and secured thereto by, for example, an over-center or other locking mechanism 875 (FIGS. 2C, 8A, and 8B). In some instances, the locking mechanism 875 may also serve to secure the trailing spars 800B, 850B together. Configured in this manner, the trailing spars 800B, 850B can be released from engagement with the body portion 300 and/or the extension member 500, and the leading spars 800A, 850A pivoted such that each wing portion 800, 850 folds to be substantially parallel to the axis 310 to facilitate stowing or storage (FIGS. 6A, 6B).

When deployed, the respective spars 800A, 800B, 850A, 850B of the wing portions 800, 850 define the corresponding leading and trailing edges, as well as the frame structure, of that wing portion, wherein the shape of the frame structure is approximately elliptical and is similar in configuration, for example, to a high aspect ratio conventional glider aircraft. The frame structure may be comprised of, for example, rods or tubes of rigid, strong, and durable, but light, material such as, for example, a polymer or a carbon fiber or carbon-fiber composite that may include, in some instances, Kevlar™ or Aramid™ fibers. In some instances, one or more wing spreader members 810 (FIG. 1) may be operably engaged between the leading and trailing spars of the respective wing portions 800, 850 so as to maintain the frame structure in the approximately elliptical deployed shape, wherein such wing spreader members 810 may be configured, for example, with over-the-center hinge mechanisms 815 (FIG. 1) for facilitating folding of the wing portions 800, 850. The frame structure is then covered with a fabric comprising any fabric material having, for example, the strength, durability, tear resistance (i.e., a “rip stop” fabric), light weight, and/or other properties suitable for the application as disclosed, and as will be appreciated by one skilled in the art. Either or both of the opposing upper and lower surfaces defined by the frame structure may be covered with the fabric, as will be further appreciated by one skilled in the art. However, in one advantageous embodiment, both of the opposing surfaces defined by the frame structure of both wing portions 800, 850 are covered with the fabric to provide performance enhancements in terms of stability, predictability, and responsiveness of the device 100, as discussed below in further detail.

In order to provide further stability for the airframe structure 200 and rigidity of the wing portions 800, 850, each wing portion 800, 850 further includes a support member 900, 950 (FIGS. 1 and 2C) extending between the body portion 300 and the respective common connection 800C, 850C of each wing portion 800, 850. In some instances, the support members 900, 950 may also be disposed between the fabric layers covering both of the opposing upper and lower surfaces defined by the frame structure of both wing portions 800, 850. The support members 900, 950 extend along the aerodynamic center (i.e., transversely to the body portion 300) of each wing portion 800, 850 so as to tension and rigidify the respective wing portion 800, 850. Such support members 900, 950 may comprise, for example, a string or a line tensioned between the respective common connections 800C, 850C, under the fabric extending over the top surface of the wing portions 800, 850, and configured for quick removal or disengagement so as to facilitate stowing and storage of the device 100. The support members 900, 950 also provide a positive camber (i.e., “concave down” profile) for the upper surface of each wing portion 800, 850. In some instances, each wing portion 800, 850 may also include a supplemental support member (not shown) for providing a camber to the bottom surface of each wing portion 800, 850. In any instance, the camber in the upper surface, as well as possibly the bottom surface serve to shape the wing portions 800, 850 in the manner of a conventional airfoil that is more stable and resistant to unrecoverable dives by the device 100. The use of fabric covering both the upper and lower surfaces of the wing portions 800, 850 also serves to create a relatively thick and constant or consistent wing profile (the same concept applies to the control surfaces—rudder and elevator), which may also facilitate increased flight stability of the device 100. In some embodiments, the wing portions 800, 850, when deployed, may also have the common connections 800C, 850C (or wingtip brackets 825) connected by a tensioning member 975 extending therebetween (FIGS. 1, 2C, and 2D). The tensioning member 975 may comprise, for example, a string or a line configured to provide a tension between the common connections 800C, 850C so as to rigidify the respective wing portions 800, 850 (in cooperation with the fabric covering either or both of the opposing upper and lower surfaces defined by the frame structure of both wing portions 800, 850) and/or to form a dihedral for increasing spiral stability of the airframe structure 200. Such a tensioning member 975 may also be configured for quick removal or disengagement from either or both of the common connections 800C, 850C so as to facilitate stowing and storage of the device 100.

In other embodiments, the wing portions 800, 850 may be configured to be operably engaged to form a discrete wing assembly with respect to the remainder of the airframe structure 200, wherein the wing assembly can be removably engaged with the body portion 300 and/or the extension member 500 to form the device 100. For example, the wing portions 800, 850 may be configured such that the respective leading spars 800A, 850A and trailing spars 800B, 850B are first secured together to form the wing assembly. The support members 900, 950 extending from each of the common connections 800C, 850C are then connected together so as to spread the leading spars 800A, 850A and trailing spars 800B, 850B apart about the lateral center of the wing assembly. In some instances, one or more wing spreader members 810 may be operably engaged between the leading and trailing spars of the respective wing portions 800, 850 so as to maintain the approximately elliptical deployed shape of the wing assembly when the leading spars 800A, 850A and trailing spars 800B, 850B are spread apart, wherein such wing spreader members 810 may be configured, for example, with over-the-center hinge mechanisms 815 to facilitate folding of the wing portions 800, 850. The wing assembly, once prepared, can then be operably engaged with the body portion 300 and/or the extension member 500, for example, through a hook member 960 (FIGS. 6A and 6B) defined by the body portion for engaging the leading spars 800A, 850A, and the locking mechanism 875 for engaging and securing the trailing spars 800B, 850B to the body portion 300 and/or the extension member 500. The wing assembly can thus be removed from the body portion 300 and/or the extension member 500, and then disassembled and folded separately of the remainder of the device 100 upon stowing or storage thereof.

In order to further facilitate a surveillance application, the device 100 may also include a controller device (not shown) operably engaged with and configured to control at least one of the image-capturing device 150, the propulsion device 600, the rudder control surface 425, and the elevator control surface 450 (and/or other components of the device 100 as disclosed herein) through appropriate connectivity, whether electrical, mechanical, or otherwise, as will be appreciated by one skilled in the art. Such a controller device may also be operably received by the body portion 300 of the device 100 and powered by the power source 700. In some instances, the controller device may be configured to be remotely actuated, such as by a remote station (not shown) that may be, for example, stationed with an operator on the ground while the device 100 is aloft. Such a remote station (preferably in wireless communication with the controller device) would, for example, allow the device 100 to be remotely controlled and/or operated such that at least one of the image-capturing device 150, the propulsion device 600, the rudder control surface 425, and the elevator control surface 450 (and/or other components of the device 100 as disclosed herein) is remotely controlled as the airframe structure 200 is at the above-ground altitude. In other instances, the controller device may be programmable to execute a particular sequence of operations (including, for instance, flight path, image capture, and landing functions), independently of any remote actuation (though there may be a manual override of that functionality of the controller device via, for example, the remote station), such that, once the device 100 is deployed, the device 100 will autonomously follow that particular sequence of events until the mission is complete.

In any event, the controller device may also include wireless transceiver functionality to allow any images captured by the image-capturing device 150, as well as, for example, any other monitored environmental or equipment parameters, to be wirelessly transmitted to a remote location for monitoring and/or recording. That is, for instance, the device 100 may include any number of components or subassemblies, for monitoring or otherwise, that are necessary for a particular mission, subject to various factors such as, for example, payload capacity of the device 100, the weight of the device 100 itself, power consumption, or other factors. For example, the device 100 may include, in some instances, any number of an audio-capturing device, a chemical sensor, a temperature sensor, a radiation detector, a sound-emitting device, a light-emitting device, a deployable explosive device, a self-destruction device, a radar device, a tracking device, a homing device, or any other device that may be suitable and/or necessary for a particular mission. Accordingly, the examples presented herein are not intended to be limiting in any respect to the functional capabilities of the device 100, whether for surveillance or otherwise.

For instance, the device 100 may also comprise a navigation device (not shown), such as a GPS device or any other suitable navigation device, operably engaged with at least the controller device. In such cases, the controller device may be responsive to the navigational device to, for example, direct the propulsion device 600, the rudder control surface 425, and/or the elevator control surface 450 (and/or other components of the device 100 as disclosed herein) to guide the airframe structure 200 from a first location to a second location, and then direct the image-capturing device 150 to capture at least one image at a waypoint between and including the first and second locations. Such a navigation device may also be used, for example, to guide the device 100 to any number of waypoints, or to capture any number of waypoints in response to an on-board or remote trigger.

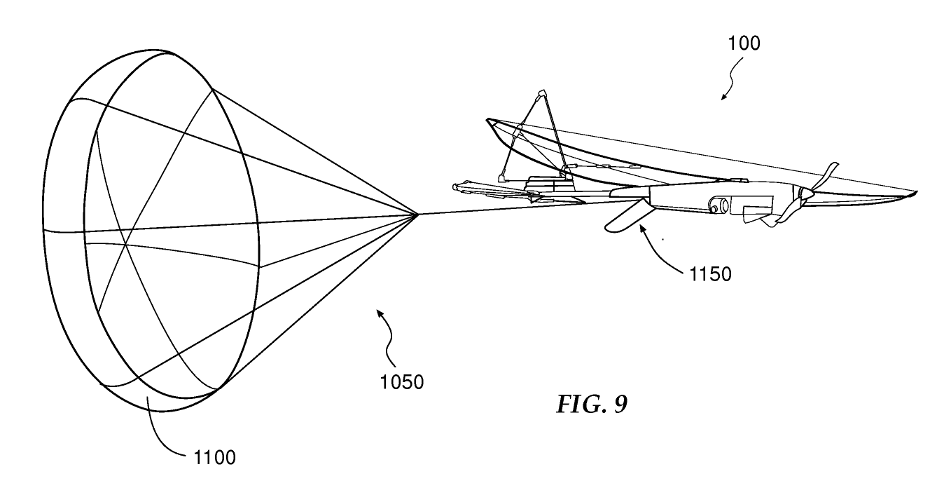

In another instance, the device 100 may also include a controlled descent and recovery system 1050 operably engaged therewith for facilitating recovery of the device 100 following completion of a flight or mission. Such a controlled descent and recovery system 1050 may comprise, for example, a parachute device 1100, as shown in FIG. 9. In one example, such a parachute device 1100 may comprise a 40 inch to 50 inch diameter round rip stop parachute canopy. The parachute device 1100 may be stowed, for instance, in an exterior pod (shown in phantom as element 1150 in FIG. 1) attached to the airframe structure 200 (such as the body portion 300) or in a section of the fuselage or body portion 300. Whether housed by the pod 1150, the body portion 300, or another portion of the airframe structure 200, the parachute device 1100 of the controlled descent and recovery system 1050 may be deployed, for example, by actuating a servo-actuated or other suitable release mechanism (not shown). The release mechanism may be operably engaged with, for instance, a trap door, a restraining strap, or other suitable securing mechanism configured to releasably secure the parachute device 1100 with respect to the pod 1150 or body portion 300, in an undeployed condition, while the device 100 is in flight.

When necessary, the parachute device 1100 of the controlled descent and recovery device 1050 may be selectively released from the pod 1150 or body portion 300 in different manners, such that the descent of the device 100 is controlled or otherwise slowed from a free-fall, thereby facilitating recovery of the device 100. In some instances, the parachute device 1100 may be deployed at a particular minimum altitude, for example, either automatically or as a step in a landing sequence. Should the propulsion device 600 be deactuated or otherwise be rendered inoperable, for instance, and the device 100 begins to descend, the securing mechanism/release mechanism may be configured so as to be responsive to an altitude condition to deploy the parachute device 1100 at a minimum altitude above the ground. In other instances, the controller device, previously discussed, may be programmable to execute a particular sequence of operations (including, for example, flight path, image capture, and landing), independently of any remote actuation, wherein the deployment of the parachute device 1100 of the controlled descent and recovery system 1050 may be included in the programming as part of the landing sequence. As before, a manual override of that functionality of the controller device, via the remote station, for example, may also be provided. In addition, the deployment of the parachute device 1100 of the controlled descent and recovery system 1050 may also be performed through “manual” actuation by an operator via the remote station and the controller device. Accordingly, one skilled in the art will appreciate that the controlled descent and recovery system 1050 may advantageously provide, for example, a “zero runway” landing capability for the device 100 and/or greater landing accuracy at a designated site. Further, the controlled descent aspect may result in less stress on the device 100 and the components thereof, which may result in less maintenance and an extended service life of the device 100. Further, the controlled descent and recovery system 1050 may also provide an emergency landing provision in the event that the device 100 experiences damage or an operational malfunction that would prevent continued flight.

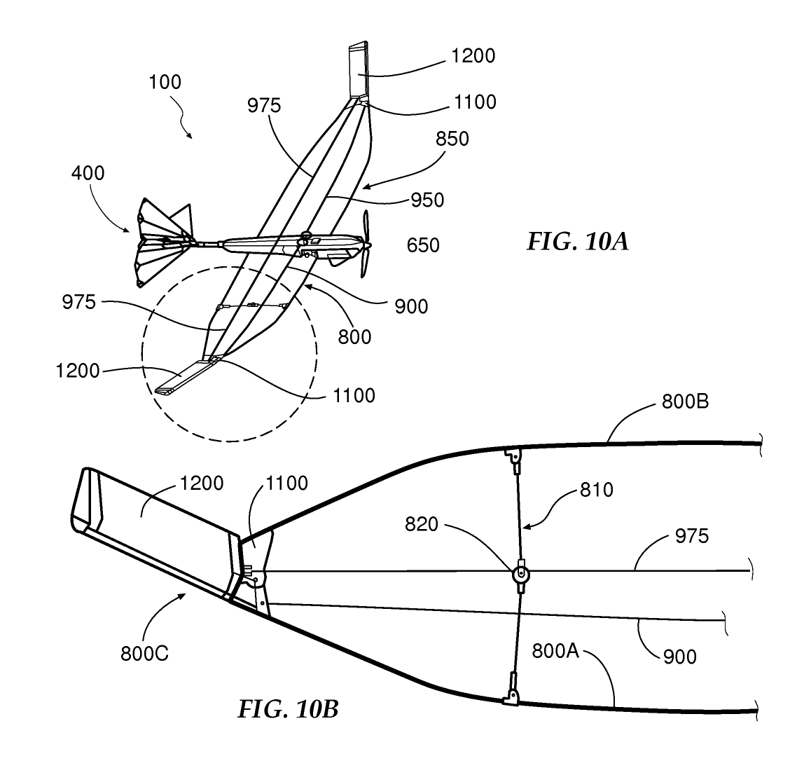

In an alternate embodiment as shown in FIGS. 10A and 10B, the transversely-opposed wing portions 800, 850 of the airframe structure 200 may be modified so as to provide different flight characteristics for the device 100. The alternate wing portions 800, 850 each comprise a leading and a trailing, or longitudinally-opposed, spars 800A, 800B, 850A, 850B, wherein the respective leading and trailing spars are operably engaged with and disposed in a spaced-apart relation along the axis 310 with respect to the body portion 300. The respective spars 800A, 800B, 850A, 850B extend substantially transversely outwardly of the body portion 300 and are attached at a common connection 800C, 850C (“wingtip”) via a wingtip bracket 1100 (FIGS. 10A and 10B).

The wing portions 800, 850 may be configured to be operably engaged to form a discrete wing assembly with respect to the remainder of the device 100, wherein the wing assembly can be removably engaged with the body portion 300 and/or the extension member 500 to form the device 100. For example, the wing portions 800, 850 may be configured such that the respective leading spars 800A, 850A and trailing spars 800B, 850B are first secured together to form the wing assembly. One or more support members 900, 950 extending from respective ones of the common connections 800C, 850C are then connected together so as to spread the leading spars 800A, 850A and trailing spars 800B, 850B apart about the lateral center of the wing assembly. In some instances, one or more wing spreader members 810 may be operably engaged between the leading and trailing spars of the respective wing portions 800, 850 so as to maintain the approximately elliptical deployed shape of the wing assembly when the leading spars 800A, 850A and trailing spars 800B, 850B are spread apart, wherein such wing spreader members 810 may be configured, for example, with pivotable hinge mechanisms 820 to facilitate folding of the wing portions 800, 850. The pivotable hinge mechanisms 820 may, in some instances, be engaged with the respective support members 900, 950 such that, when the support members 900, 950 are tensioned so as to be connected together, the pivotable hinge mechanisms 820 are deployed to support the spacing between the leading and trailing edges of the wing portions 800, 850.

The wing assembly, once prepared, can then be operably engaged with the body portion 300 and/or the extension member 500, for example, through a hook member 960 (FIGS. 6A and 6B) defined by the body portion 300 for engaging the leading spars 800A, 850A, and the locking mechanism 875 for engaging and securing the trailing spars 800B, 850B to the body portion 300 and/or the extension member 500. The wing assembly can thus be removed from the body portion 300 and/or the extension member 500, and then disassembled and folded separately of the remainder of the device 100 upon stowing or storage thereof

The wing assembly, once deployed and operably engaged with the body portion 300 and/or the extension member 500, may have the common connections 800C, 850C (or wingtip brackets 1100) thereof connected by a tensioning member 975 extending therebetween (FIGS. 10A and 10B). In other instances, a tensioning member 975 engaged with each wingtip bracket 1100 may be connected to the body portion 300 and/or the extension member 500 to rigidify the respective wing portions 800, 850 (in cooperation with the fabric covering both of the opposing surfaces defined by the frame structure of both wing portions 800, 850) and/or to form the dihedral for increasing spiral stability of the airframe structure 200. In either instance, the tensioning member(s) 975 is/are also configured for quick removal or disengagement so as to facilitate stowing and storage of the device 100.

As shown in FIGS. 10A and 10B, the device 100 may further comprise aileron members 1200 operably engaged with each wingtip such as, for example, with the respective wingtip brackets 1100. Each aileron member 1200 may include, for instance, a servo mechanism (not shown) for providing control of the aileron members 1200 via the controller device. When the aileron members 1200 are included in the wing assembly, the dihedral of the wing portions 800, 850 may be decreased because of the dihedral provided by the angled aileron members 1200. That is, the aileron members 1200 may be configured and/or angled so as to provide the aerodynamic stability of the dihedral, while the wing portions 800, 850 are configured with lesser or no dihedral. In this manner, the roll and yaw axes of the wing assembly are essentially separated.

As such, embodiments of the present invention provide an unmanned aerial surveillance device 100 capable of deployment in a variety of situations, for example, in law enforcement and military applications. The device 100 can be configured to be lightweight (in one example, such a device may be configured to weigh on the order of 5 pounds or less and be in a “backpack” transportable class of devices), and capable of capturing aerial surveillance images up to the optical limitations of the image-capturing device 150 (for example, on the order of between about 200 and about 400 feet above the ground for one particular camera device), while being capable of operating on on-board power (battery-dependent) in a relatively silent manner for the required mission duration (in one example, on the order of several hours). In one instance, the device 100 may be disassembled and stored in an appropriate case, for example, a tubular storage container 1000 (FIGS. 6A and 6B) on the order of about 6 inches in diameter and about 48 inches in length, by a single operator within minutes. The device 100 is further configured such that the same single operator can readily reassemble and deploy the device 100 within minutes of removal of the device 100 from the container 1000, as well as operate the device 100 from a remote station on the ground.

Embodiments of the present invention thus provide an unmanned aerial surveillance device that is lighter, less bulky, durable, responsive, and stable, as well as a device capable of accommodating various components and sub-assemblies, as well as any payload, in an efficient and readily adaptable manner.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An unmanned aerial surveillance device, comprising:
an image capturing device;
an airframe structure having the image-capturing device operably engaged therewith and configured to be capable of supporting the image-capturing device at an above-ground altitude, said airframe structure including:
an elongate body portion defining a longitudinal axis;
a tail portion operably engaged with the body portion along the axis and comprising a rudder control surface and an elevator control surface;
a pair of transversely-opposed wing portions directly and operably engaged with the body portion and extending substantially transversely thereto, each wing portion being defined by longitudinally-opposed spars extending from a spaced-apart disposition at the body portion to a common connection disposed distally with respect to the body portion, the spars having a fabric extending therebetween so as to provide a wing surface; and
a support member extending along an aerodynamic center, transversely to the body portion, of each wing portion, the support members being configured to tension and rigidify the wing portions so as to provide a positive camber for each wing portion and to form an airfoil.

2. A device according to claim 1 wherein each support member extends from the common connection of each wing portion to engage at least one of the body portion and each other, so as to rigidify the wing portions.

3. A device according to claim 1 further comprising a tensioning member extending between the common connections of the transversely-opposed wing portions and configured to provide a tension therebetween so as to rigidify the wing portion and form a dihedral.

4. A device according to claim 1 further comprising a tensioning member extending between each common connection of the transversely-opposed wing portions and the body portion, the tensioning members being configured to provide a tension between each common connection and the body portion so as to rigidify the respective wing portion and form a dihedral.

5. A device according to claim 1 wherein the image capturing device is at least partially housed by the airframe structure.

6. A device according to claim 1 wherein the image-capturing device is configured to at least one of pan, tilt, and zoom with respect to the airframe structure.

7. A device according to claim 1 wherein the image capturing device is stabilized with respect to the airframe structure.

8. A device according to claim 1 wherein the image capturing device is gyroscopically stabilized.

9. A device according to claim 1 further comprising a propulsion device operably engaged with the body portion of the airframe structure for providing forward propulsion for the airframe structure.

10. A device according to claim 9 wherein the propulsion device further comprises a propeller member having a plurality of blades and being configured to be rotated by a motor so as to provide the forward propulsion for the airframe structure, the blades of the propeller member being foldable to extend substantially parallel to the axis.

11. A device according to claim 9 further comprising a power source operably engaged with at least one of the image-capturing device and the propulsion device and configured to provide power therefor, the power source being supported by the airframe structure.

12. A device according to claim 1 further comprising a controller device operably engaged with and configured to control at least one of the image-capturing device, the propulsion device, the rudder control surface, and the elevator control surface.

13. A device according to claim 12 wherein the controller device is at least partially housed by the body portion of the airframe structure and is configured to be remotely actuated.

14. A device according to claim 13 further comprising an actuator device configured to be in wireless communication with the controller device and to remotely actuate the controller device, so as to allow the at least one of the image-capturing device, the propulsion device, the rudder control surface, and the elevator control surface to be remotely controlled as the airframe structure is at the above-ground altitude.

15. A device according to claim 12 further comprising a navigation device operably engaged with at least the controller device, the controller device being responsive to the navigational device to direct the at least one of the image-capturing device, the propulsion device, the rudder control surface, and the elevator control surface to guide the airframe structure from a first location to a second location and the image-capturing device to capture at least one image at a waypoint between and including the first and second locations.

16. A device according to claim 1 further comprising an extension member operably engaged between the body portion and the tail portion so as to separate the tail portion from the body portion along the axis.

17. A device according to claim 1 further comprising an explosive device releasably engaged with the airframe structure and configured to be selectively released while the airframe structure is at the above-ground altitude.

18. A device according to claim 1 further comprising an audio-capturing device operably engaged with the airframe structure so as to be supported thereby.

19. A device according to claim 1 wherein the tail portion and each of the wing portions is configured to be foldable toward and along the axis such that, when folded, the airframe structure is configured to be received by a tubular storage container.

20. A device according to claim 1 wherein the wing portions are configured to be removable from the airframe structure, and wherein the wing portions and the tail portion are foldable such that, when folded, the wing portions and the airframe structure are configured to be received by a tubular storage container.

21. A device according to claim 1 further comprising a selectively actuatable controlled descent and recovery system operably engaged with the airframe structure and configured to slow a descent thereof.

22. A device according to claim 21 wherein the controlled descent and recovery system further comprises a selectively deployable parachute device.

23. A device according to claim 1 further comprising an aileron member operably engaged with the common connection of each wing portion, the aileron members being controllable to affect the roll of the device.

24. A device according to claim 1 further comprising at least one spreader member operably engaged between the longitudinally-opposed spars of each wing portion so as to separate the spars into the spaced-apart disposition.

25. A device according to claim 24 wherein the support member of each wing portion is operably engaged with the at least one spreader member of that wing portion such that, upon the support member being deployed to tension and rigidify that wing portion, the support member deploys the at least one spreader member to separate the spars into the spaced-apart disposition.
